(19) United States
(12) Patent Application Publication
(10) Pub. No.: US 2024/0238741 A1
(43) Pub. Date: Jul. 18, 2024

(54) STIRRER, MACHINE COMPRISING THE STIRRER FOR PROCESSING LIQUID, SEMI-LIQUID OR SEMI-SOLID FOOD PRODUCTS, AND PROCESSING METHOD

(71) Applicant: ALI GROUP S.R.L. - CARPIGIANI, Cernusco Sul Naviglio (Milano) (IT)

(72) Inventors: Roberto LAZZARINI, Reggio Emilia (IT); Federico TASSI, Bologna (IT)

(21) Appl. No.: 18/535,059

(22) Filed: Dec. 11, 2023

(30) Foreign Application Priority Data
Jan. 17, 2023 (IT) 102023000000537

(51) Int. Cl. B01F 27/072; B01F 27/112; B01F 35/92; B01F 101/07

(52) U.S. Cl. CPC B01F 27/0727; B01F 27/112; B01F 35/92; B01F 2101/07

(57) ABSTRACT

Described is a stirrer for liquid, semi-liquid or semi-solid products, including at least the following, in combination:
a central shaft;
a plurality of radial supports, connected to the central shaft;
a plurality of mixing and centring elements, each configured to be connected to a radial support so as to define a first operating configuration for processing liquid or semi-liquid products;
a plurality of vanes, each configured to be connected to a mixing and centring element so as to define a second operating configuration for processing semi-solid products.

This application claims priority to Italian patent application Ser. No. 102023000000537 filed Jan. 17, 2023, the entirety of which is incorporated by reference herein.

This disclosure relates to a stirrer and a machine for processing and treating food products (liquid and/or semi-liquid and/or semi-solid), in particular products for the bakery and confectionery trade, creams, dessert mixtures or the like.

Generally speaking, these machines comprise a container for containing the product to be processed, a stirrer mounted inside the container and used for mixing the product, and at least one dispensing tap mounted at the bottom of the front of the container.

In machines of this kind, where the product to be stirred has a liquid or semi-liquid consistency, a first stirrer is used, which is provided with a shaft and vanes especially designed for stirring.

These vanes usually have contact elements made of plastic material, which allow centring the stirrer relative to the container and, at the same time, reducing friction while the stirrer rotates.

On the other hand, when the products to be stirred are creamy, in particular dessert products, a second stirrer is usually used, which is provided with vanes which are larger in surface area, hence more suitable for mixing products which are very creamy.

A particularly strongly felt need in the trade concerned is therefore to be able to have a single stirrer capable of very effectively treating liquid or semi-liquid mixtures as well as creamy desserts, and of producing particularly high product quality in both cases.

The aim of this innovation is to meet the above-mentioned need, that is to say, to provide a stirrer capable of very effectively mixing not only liquid or semi-liquid mixtures but also products having a thicker consistency, such as creams or dessert products.

Another aim of this innovation is to provide a stirrer which is quick and easy to remove so as to ensure optimum cleaning.

A further aim of this innovation is to provide a machine which allows working with food products in a particularly efficient manner, be they liquid, semi-liquid or semi-solid.

The description refers to the accompanying drawings, which are also provided purely by way of non-limiting example and in which:

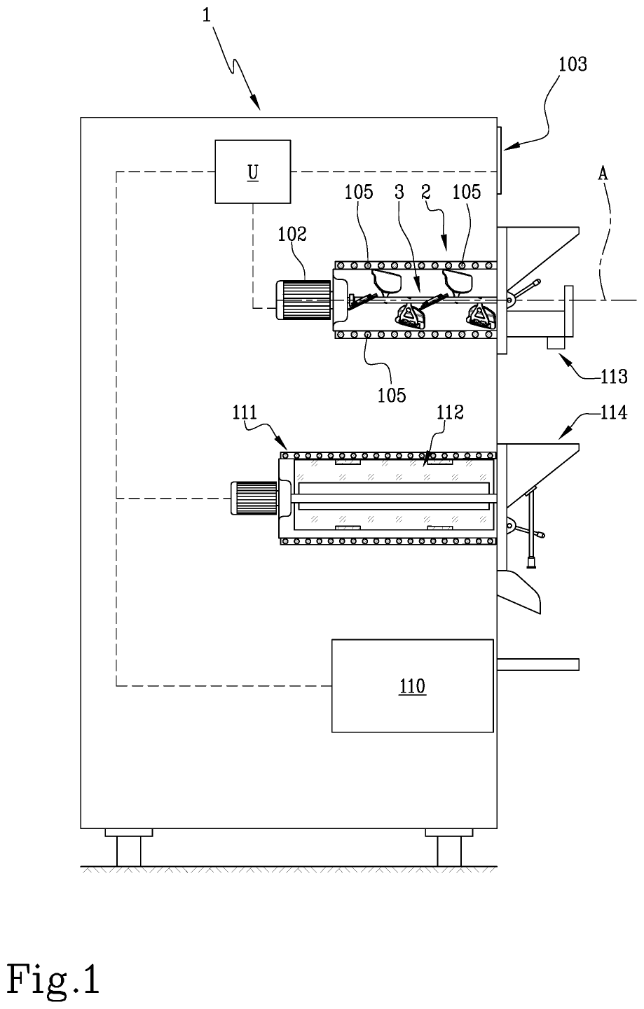

FIG. 1 shows a schematic side view of the machine according to this innovation;

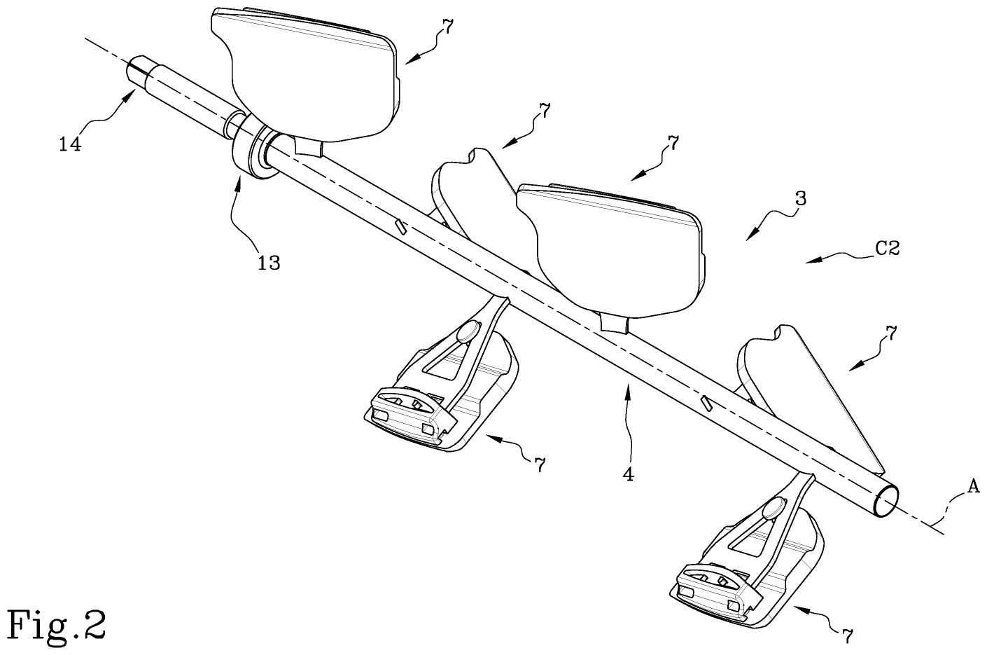

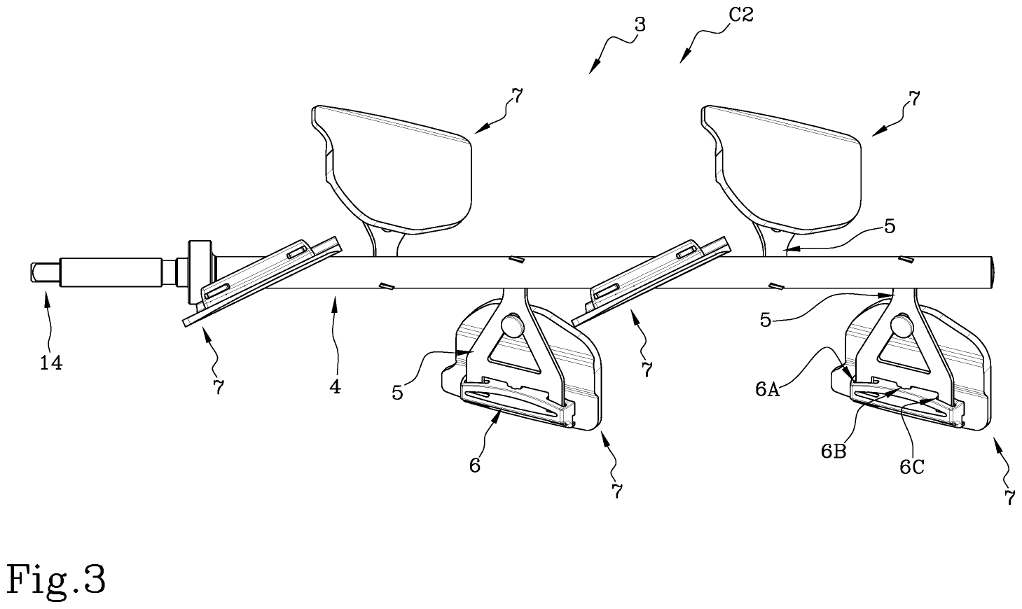

FIGS. 2 and 3 show respective perspective views of a stirrer forming part of the machine of FIG. 1 in a first operating configuration;

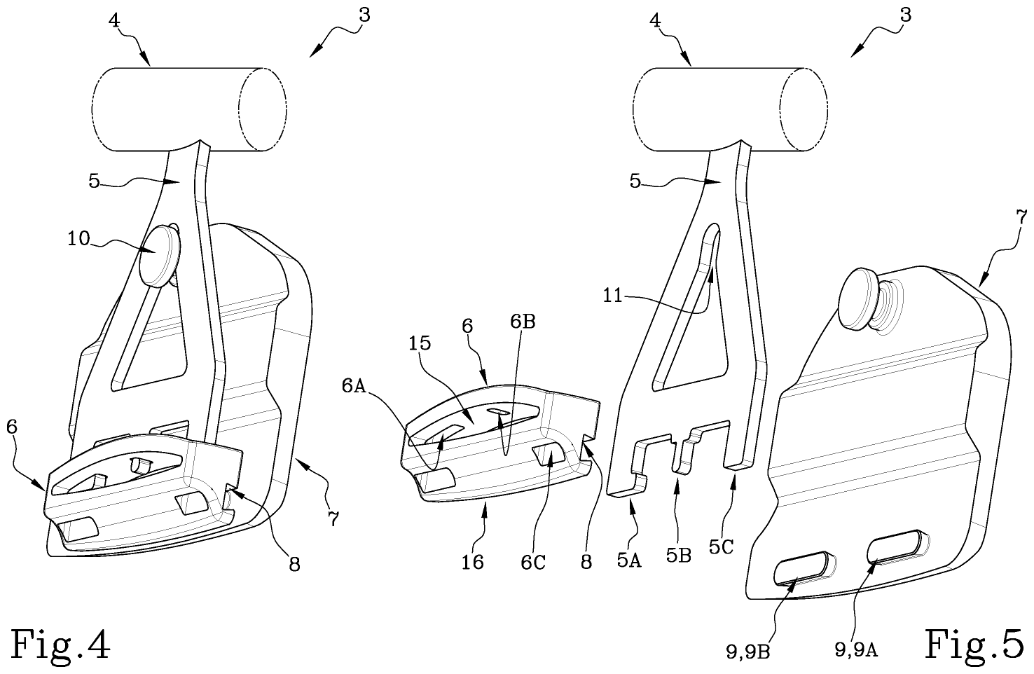

FIGS. 4 and 5 show respective perspective views of a detail of the stirrer of FIGS. 2 and 3 in an assembled and a disassembled configuration, respectively;

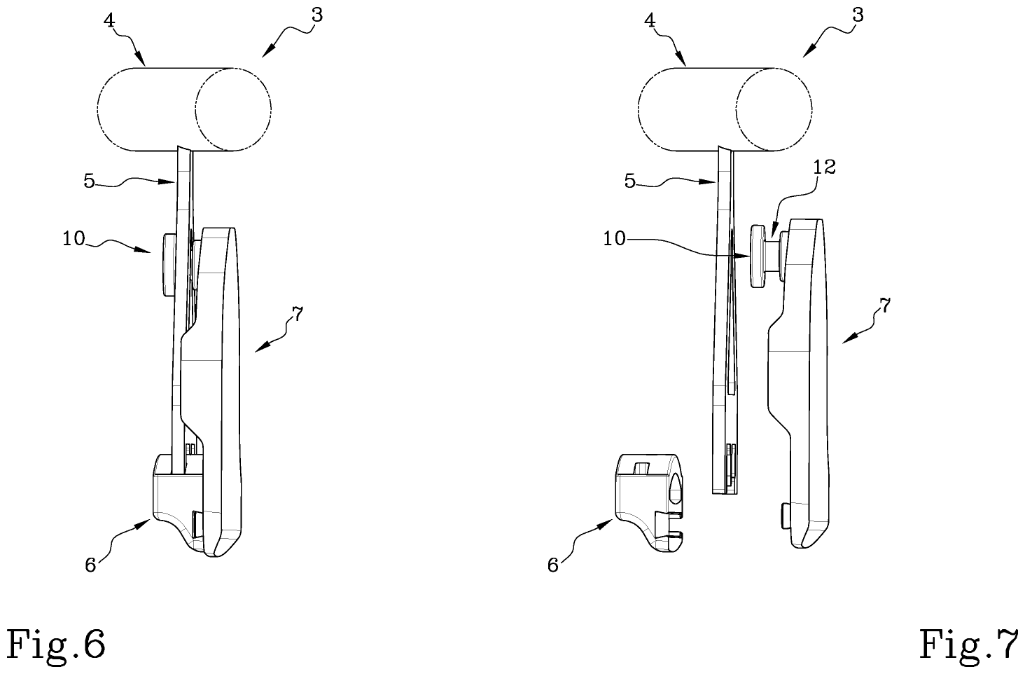

FIGS. 6 and 7 show respective side views of a detail of the stirrer of FIGS. 2 and 3 in an assembled and a disassembled configuration, respectively;

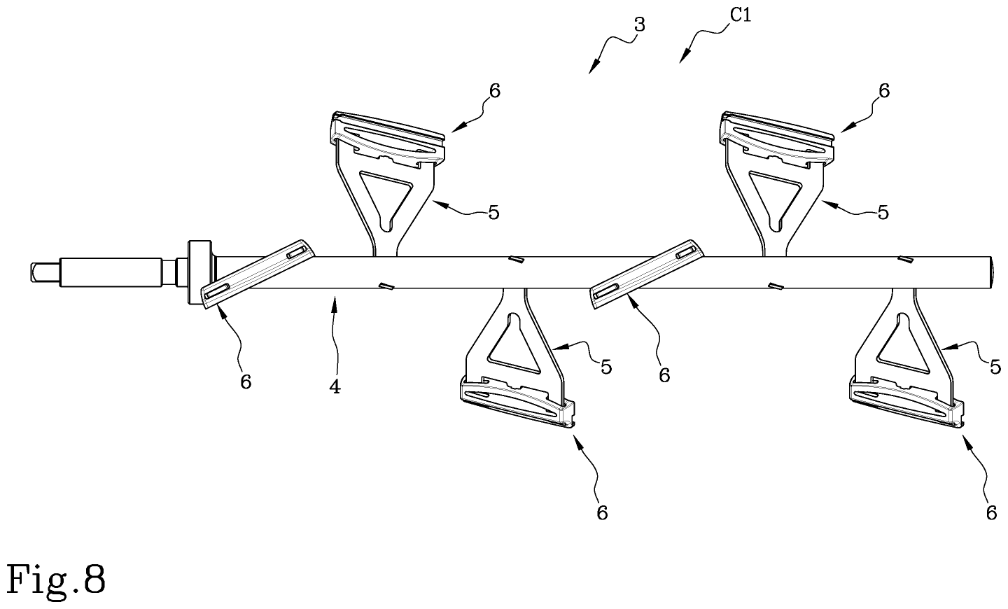

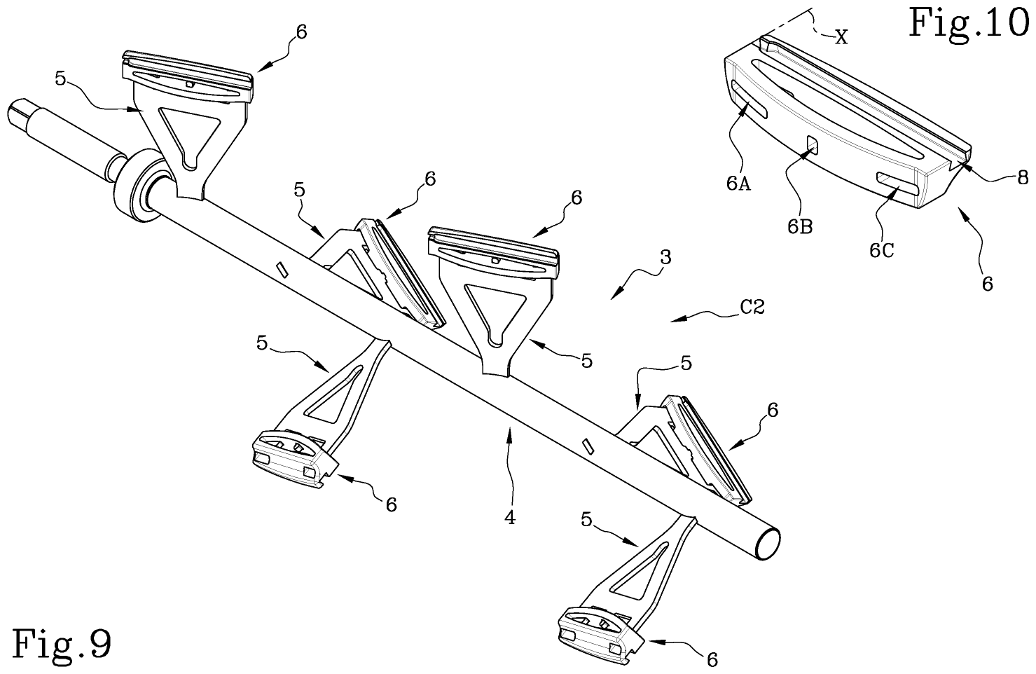

FIGS. 8 and 9 show respective perspective views of a stirrer forming part of the machine of FIG. 1 in a second operating configuration;

FIG. 10 shows a perspective view of a detail of the stirrer of FIGS. 2 to 9.

With reference to the accompanying drawings, the reference numeral 1 denotes in its entirety a machine for processing food products, preferably liquid, or semi-liquid, or semi-solid, in particular for making (or treating) and dispensing the aforesaid products.

For example, the aforesaid food products may be creams, desserts, mixtures for ice cream or dessert products, jams or other similar products.

According to the disclosure, the machine 1 for making and dispensing food products comprises at least one container 2, for containing the product to be processed.

The container 2 comprises lateral and bottom inside walls.

Preferably, the container 2 is a cylindrical container.

Still more preferably, the container 2 has a horizontal axis.

According to the disclosure, the machine 1 for making and dispensing food products comprises at least one stirrer 3, mounted inside the container 2.

The stirrer 3 is the object of the invention.

The stirrer 3 comprises a central shaft 4 rotating about an axis of rotation A.

The stirrer 3 further comprises a plurality of radial supports 5, connected to the central shaft 4.

Preferably, the radial supports 5 are made from a metallic material.

Preferably, the radial supports 5 are irremovably connected to the central shaft 4.

Still more preferably, the radial supports 5 are welded to the central shaft 4.

The stirrer 3 further comprises a plurality of mixing and centring elements 6, each configured to be connected to a radial support 5.

According to another aspect, the stirrer 3 also comprises a plurality of mixing and centring vanes 7, each configured to be connected (removably) to a mixing and centring element 6.

The stirrer 3 according to this invention can be assembled in two different configurations, a first configuration C1 (FIGS. 8 and 9) and a second configuration (FIGS. 2 and 3).

It should be noted that in the first configuration C1 (FIGS. 8 and 9), the mixing and centring elements 6 are each connected to a radial support 5.

Under these conditions, the stirrer 3 is composed only of the central shaft 4, the mixing and centring elements 6 and the radial supports 5.

It should be noted that the first configuration C1 is suitable for mixing predominantly liquid or semi-liquid products, that is, products whose main component is liquid, in particular mixtures for any ice cream or dessert products.

Such products basically consist of mixtures which are used for the production of finished products.

It should be noted that in the second configuration C2 (FIGS. 2 and 3), the vanes 7 are connected to the mixing and centring elements 6 (in the manner described in more detail below).

Each assembly composed of a vane 7 and a mixing and centring element 6 is then coupled to a radial support 5 by coupling the mixing and centring element 6 to a radial support 5.

In the second configuration C2 (FIGS. 2 and 3), the stirrer 3 is composed only of the central shaft 4, the mixing and centring elements 6, the vanes 7 and the radial supports 5.

It should be noted that the second configuration C2 is suitable for mixing predominantly thick (semi-solid) products such as, by way of non-limiting example: creams, desserts, icings, jellies, spreadable creams, jams, mousses, waffles, namelaka, toppings, blancmange, fruit coulis, fruit creams, crème anglaise, fruit sauce.

According to another aspect, each radial support 5 has at least one plurality of prongs 5A, 5B, 5C.

According to yet another aspect, each mixing and centring element 6 has a plurality of cavities 6A, 6B, 6C.

Each cavity 6A, 6B, 6C is configured to receive one of the prongs 5A, 5B, 5C within it.

According to yet another aspect, a first prong 5A of the plurality of prongs 5A, 5B, 5C is a lower lateral prong, a second prong 5B of the plurality of prongs 5A, 5B, 5C is an upper lateral prong, and a third prong 5C of the plurality of prongs 5A, 5B, 5C is a central prong.

According to another aspect, a first cavity 6A of the plurality of cavities 6A, 6B, 6C is a lower cavity configured to be coupled to the lower lateral prong 5A, a second cavity 6B of the plurality of cavities 6A, 6B, 6C is an upper cavity configured to be coupled to the upper lateral prong 5B, and a third cavity 6C of the plurality of cavities 6A, 6B, 6C is a central cavity configured to be coupled to the central prong 5C.

According to yet another aspect, each mixing and centring element 6 has an elongate seat 8, and each vane 7 comprises at least one protrusion 9 configured to be slotted into the seat 8 so as to join the mixing and centring vane 7 to the mixing and centring element 6.

Preferably, the seat 8 is parallelepipedal in shape.

According to another aspect, the protrusion 9 is parallelepipedal in shape.

Preferably, the protrusion 9 has rounded edges on both sides (for easier insertion into the seat 8).

It should be noted that the protrusion 9 is inserted by sliding it into the seat 8.

Basically, the seat 8 is open at least at one end of it to allow the protrusion 9 to be slidably inserted into it, thereby coupling the vane 7 and the mixing and centring element 6 to each other.

Once the vane 7 and the mixing and centring element 6 have been coupled, they define the aforesaid assembly, composed of vane 7 and mixing and centring element 6, which can be coupled to the radial support 5 to define the second operating configuration of the stirrer 3.

According to another aspect, each vane 7 comprises a plurality of protrusions 9, configured to be inserted into the seat 8 to couple the mixing and centring vane to the radial supporting element 5.

More preferably, as illustrated in the accompanying drawings, each vane 7 comprises a first protrusion 9A of the plurality of protrusions 9 and a second protrusion 9B of the plurality of protrusions 9.

Insertion of the first and the second protrusion 9A, 9B into the seat 8 is carried out as described above, by sliding.

According to another aspect, the mixing and centring element 6 is also provided with a recess 15; the recess 15 is shaped to ensure that the edge portion 16 of the mixing and centring element which, in use, abuts against the surface of the container 2, has the necessary elastic compliance.

Basically, thanks to the presence of the recess, the mixing and centring element 6 is elastically compliant along the direction X.

That way, the mixing and centring element 6 acts in substantially the same way as a spring, along the direction X, that is to say, it is capable of elastically deforming, accumulating elastic energy, and then returning to the original position.

This allows the stirrer 3 to be perfectly centred in the internal cylindrical space defined by the container 2.

It should be noted that the mixing and centring element 6 has a twofold function: when the stirrer 3 is in the first configuration C1, it acts as a mixing and centring element in conjunction with the radial supports 5.

The mixing and centring element 6 also allows centring the stirrer 3 relative to the walls of the container 2: in effect, since the central shaft 4 is quite long, the mixing and centring element 6 is in contact with the walls of the container 3 and allows substantially aligning the axis of the central shaft 4 with the axis of the container 2.

In particular, the edge 16 of the mixing and centring element 6 is in contact with the walls of the container 2.

It should also be noted that the vanes 7 are preferably disposed longitudinally along the container 2 and oriented in such a way that they at least partly overlap as they operate during the rotation of the shaft 4. In other words, the zone covered by the rotation of one vane 7 at least partly intersects the zone covered by the rotation of another vane 7, adjacent to it.

According to yet another aspect, each radial support 5 comprises a receiving slot 11, and each vane 7 comprises a coupling pin 10 configured to be inserted into the receiving slot 11 to be coupled thereto.

Preferably, the coupling pin 10 is cylindrical in shape.

According to another aspect, the coupling pin 10 comprises a (radial) groove 12, configured to be coupled to the walls of the receiving slot 11 of the radial support 5.

According to yet another aspect, the central shaft 4 and radial supports 5 are made from a first, metallic material, and the mixing and centring elements 6 and vanes 7 are made from a second material, which is different from the first material and which is not metallic (preferably plastic material).

It should be noted that the fact that the second material is a plastic material, such as ABS, polyethylene, etc., advantageously allows eliminating wear on the walls of the container 2.

In effect, the walls of the container 2 are made from a metallic material.

According to yet another aspect, the stirrer 3 comprises a sing 13, connected to the central shaft 4.

Preferably, the ring 13 defines a point of contact wih the bottom wall of the container 2.

According to yet another aspect, at least some of the vanes 7 lie substantially in parallel planes.

More preferably, the vanes 7 lie in parallel planes in pairs.

According to yet another aspect, the central shaft 4 extends along a main direction of extension A and the radial supports 5 are connected to the central shaft 4 at different positions relative to the main direction of extension A.

According to an aspect of this disclosure, the machine 1 comprises a motor 102, connected to the central shaft 4 of the stirrer 3 to set the stirrer 3 (more precisely, the central shaft 4) in rotation about the axis of rotation A.

More precisely, the central shaft 4 comprises a portion 14 having a non-circular shape, configured to be coupled to the motor 102.

According to another aspect of this disclosure, the machine 1 comprises thermal treatment means 110.

Preferably, the thermal treatment means 110 are configured to heat the product inside the container 2.

Preferably, the thermal treatment means 110 are configured to heat the product inside the container 2 to a temperature of between 40° C. and 85° C.

The thermal treatment means 110 are associated with the container 2 to thermally treat the product contained therein.

According to an aspect, the thermal treatment means 110 comprise at least one thermodynamic system (illustrated schematically in the accompanying drawings).

The thermodynamic system comprises a closed circuit configured to cause a heat exchanger fluid to circulate therein.

It should be noted that the structure and mechanics of the stirrer 3 in the first operating configuration C1 allows the product being processed in the machine 1 to be effectively mixed and blended while it is being heated.

In effect, in particular, heating could cause the product being processed to be overheated at the points where the product adheres to the inside walls of the container 2. It is therefore necessary to prevent the product from sticking to the walls of the container 2 in any way.

According to a further aspect of this disclosure, the machine 1 comprises a control unit U.

The control unit U is configured to drive the motor 102 and/or to control the thermal treatment means 110.

In an embodiment, the machine 1 comprises an interface 103 which is operatively connected to the control unit U and is configured to allow interaction with a user.

Preferably, the machine 1 comprises a dispenser 113, connected to the container 2 which contains the product to be processed to allow extracting the product to be processed.

The dispenser 113 preferably comprises a control lever, configured to open or close a duct which is in communication with the interior of the container 2.

According to another aspect, the machine 1 comprises an additional container 111 and an additional stirrer 112 disposed inside the additional container 111.

Preferably, the additional container 111 is configured to cool the product being processed.

In this sense, the additional container 111 is connected to the thermal treatment means 110 to allow the product inside the container 111 to be cooled while it is being stirred by the additional stirrer 112.

Preferably, the thermal treatment means 110 are configured to cool the product inside the additional container 111 to a temperature of between 0° C. and −15° C., more preferably between −3° C. and −10° C.

It should be noted that the additional container 111 advantageously allows making ice cream products, for example, gelati or cold dessert products.

In this sense, the base product may be pre-treated, for example pasteurized, in the container 2, then extracted with the dispenser 113 and fed to the container 111, through the hopper 114, to be processed therein.

Also defined is a method for processing liquid, semi-liquid or semi-solid products by means of a stirrer 3 according to what is described in the foregoing, comprising the following steps:
preparing a stirrer 3 as described in the foregoing;
preparing a processing container 2; and alternatively:
if the product is a liquid or semi-liquid product, coupling each mixing and centring element 6 to a radial support 5 (of the radial supports 5) so as to define the first operating configuration C1 of the stirrer 3;
if the product is a semi-solid product:
   coupling each vane 7 to a mixing and centring element 6 so as to define an assembly composed of vane 7 and mixing and centring element 6;
   and coupling to a radial support 5 each assembly made up of a vane 7 and a mixing and centring element 6 coupled to each other to define a second operating configuration C2 of the stirrer 3;
mounting the stirrer 3 in the container 2 according to the first operating configuration C1 or the second operating configuration C2;
setting the central shaft 4 in rotation to process the product inside the container 2 and simultaneously thermally treating, preferably heating, the walls of the container 2.

Advantageously, according to the invention, it is possible to have a single stirrer 3, that is to say, to assemble the stirrer extremely easily and flexibly based on the product being processed.

This advantageously allows using a single central shaft 4 and being able to configure the shaft in the first or the second configuration (C1, C2) based on the product being processed.

Advantageously, fitting and removing the different parts on the radial supports 5 is extremely easy, thanks to the coupling features described in the foregoing.

Thus, cleaning and maintenance of the stirrer 3 is made extremely easy.

Moreover, thanks to the mixing and centring elements 6, the central shaft 4 can be centred in the container 2 very efficiently and wear due to the rotation of the stirrer 3 is greatly reduced.

1. A stirrer for liquid, semi-liquid or semi-solid products, comprising at least the following, in combination:
a central shaft;
a plurality of radial supports, connected to the central shaft;
a plurality of mixing and centring elements, each configured to be connected to a radial support so as to define a first operating configuration for processing liquid or semi-liquid products;
a plurality of vanes, each configured to be connected to a mixing and centring element so as to define a second operating configuration for processing semi-solid products.

2. The stirrer according to claim 1, wherein each radial support has at least one plurality of prongs.

3. The stirrer according to claim 2, wherein each mixing and centring element has a plurality of cavities, each cavity being configured to receive one of the prongs so as to connect the mixing and centring element to one of the radial supports.

4. The stirrer according to claim 2, wherein a first prong of the plurality of prongs is a lower lateral prong, a second prong of the plurality of prongs is an upper lateral prong, and a third prong of the plurality of prongs is a central prong, and wherein a first cavity of the plurality of cavities is a lower cavity configured to be coupled to the lower lateral prong, a second cavity of the plurality of cavities is an upper cavity configured to be coupled to the upper lateral prong, and a third cavity of the plurality of cavities is a central cavity configured to be coupled to the central prong.

5. The stirrer according to claim 2, wherein each mixing and centring element has an elongate seat, and wherein each vane comprises at least one protrusion configured to be slotted into the elongate seat so as to join the mixing and centring vane to the radial support.

6. The stirrer according to claim 5, wherein each mixing and centring element has an elongate seat and wherein each vane comprises a plurality of protrusions configured to be slotted into the elongate seat so as to join the mixing and centring vane to the radial support.

7. The stirrer according to claim 1, wherein each radial support comprises a receiving slot, and wherein each vane comprises a coupling pin configured to be inserted into the receiving slot to be coupled thereto.

8. The stirrer according to claim 7, wherein the coupling pin comprises a groove, configured to be coupled to the walls of the receiving slot of the radial support.

9. The stirrer according to claim 1, wherein the central shaft and radial supports are made from a first, metallic material, and the mixing and centring elements and vanes are made from a second material, which is different from the first material and which is not metallic.

10. The stirrer according to claim 1, wherein the stirrer comprises a ring integrally connected to the central shaft.

11. The stirrer according to claim 1, wherein at least some of the vanes lie substantially in parallel planes.

12. The stirrer according to claim 1, wherein the central shaft extends along a main direction of extension and wherein the radial supports are connected to the central shaft at different positions relative to the main direction of extension.

13. A machine for processing liquid or semi-liquid food products, comprising:
at least one container for containing the product to be processed;
a stirrer according to claim 1, disposed inside the container;
a thermal system, operatively connected to the container to heat the walls thereof.

14. The machine according to claim 13, further comprising a dispenser, connected to the container containing the product to be processed to allow the product to be processed to be extracted.

15. The machine according to claim 13, comprising an additional container and an additional stirrer disposed inside the additional container.

16. A method for processing liquid, semi-liquid or semi-solid products by means of a stirrer according to claim 1, comprising the following steps:
preparing a stirrer;
preparing a processing container; and alternatively:
if the product is a liquid or semi-liquid product, coupling each mixing and centring element to a radial support so as to define the first operating configuration;
if the product is a semi-solid product:
coupling each vane to a mixing and centring element;
and coupling to a radial support each assembly made up of a vane and a mixing and centring element coupled to each other to define a second operating configuration;
mounting the stirrer in the container according to the first operating configuration or the second operating configuration;
setting the central shaft in rotation to process the product and simultaneously thermally treating, preferably heating, the walls of the container.
